(19) United States
(12) Patent Application Publication
(10) Pub. No.: US 2019/0050885 A1
(43) Pub. Date: Feb. 14, 2019

(54) REWARD COLLECTION SYSTEM AND RELATED METHOD

(71) Applicant: Sheng-Chun Lin, New Taipei City (TW)

(72) Inventor: Sheng-Chun Lin, New Taipei City (TW)

(21) Appl. No.: 15/672,301

(22) Filed: Aug. 9, 2017

(51) Int. Cl. G06Q 30/02

(52) U.S. Cl. CPC G06Q 30/0225; G06Q 30/0226

(57) ABSTRACT

An award collection system and method are disclosed. Firstly, a server device delivers various jigsaw pieces with associated authentication data to a a store device. A customer device is data-linked to the server device so as to locate surrounding general and franchised stores, and determine routes to the stores. After a customer has shopped in a franchised store, the customer device receives a number of jigsaw pieces from the store device. Two near-by customers may exchange their jigsaw pieces through their customer devices. A complete set of jigsaw pieces may be redeemed through the customer device for a reward from the server device. As such business is enhanced and customer patronage is attracted.

### BACKGROUND OF THE INVENTION

### (a) Technical Field of the Invention

The present invention generally relates to sales and business and, more particularly, to a reward collection system and a related method for attracting and encouraging customer patronage.

### (b) Description of the Prior Art

To encourage patronage, many retail stores distribute loyalty cards to their customers. The customers are rewarded points or similar tokens when their expenditure there has reached a certain amount. And as the points on the loyalty cards are accumulated to a certain number, the points may be used to redeem various prizes or commodities. However, the collection process may be quite boring and customers collect their points individually without interaction.

### SUMMARY OF THE INVENTION

A major objective of the present invention is to attract customer patronage and to promote business in franchised stored.

Another objective of the present invention is to encourage customer interaction and to enhance reward collection speed and probability.

The award collection system includes a server device, at least a store device, and at least a customer device. The server device includes a server jigsaw unit, a map unit, a server exchange unit, and a server redemption unit. The server jigsaw unit generates a number of jigsaw pieces for customer collection where each jigsaw piece is associated with an authentication datum for anti-counterfeiting. The map unit provides a number of franchised store data regarding stores participating reward collection, a number of general store data, and a map datum through which the franchised and general store data are inspected. The server exchange unit provides customer devices to exchange jigsaw pieces. The server redemption unit allows customer devices to redeem their collected jigsaw pieces.

Each store device is data-linked with the server device, and includes a store jigsaw unit for receiving and storing jigsaw pieces from the server jigsaw unit, and a store security unit for the prevention of fraud.

Each customer device is data-linked with the server device, and includes a customer jigsaw unit for receiving and storing jigsaw pieces from the store jigsaw unit, a customer exchange unit for the exchange of jigsaw units with another customer exchange unit, and a customer redemption unit for the redemption of a reward using the stored jigsaw pieces.

The award collection system functions as follows. Firstly, each store device is data-linked to the server device, where the server jigsaw unit of the server device delivers various jigsaw pieces with associated authentication data to the store jigsaw units of the store devices. Each customer device is data-linked to the server device, where the map datum, franchised store data, general store data are obtained from the map unit of the server device so that a customer is able to inspect the map datum of a customer device, locate surrounding general and franchised stores, and determine routes to the stores.

Then, the store security unit of a store device unlocks the store jigsaw unit to transmit a specific number of jigsaw pieces to the customer jigsaw unit of the customer device, after the customer has shopped in a franchised store.

The customer exchange unit of the customer device is data-linked with the server exchange unit of the server device, where the server exchange unit determines whether two customer devices are at close proximity and then allows the near-by customer exchange units to exchange selected jigsaw pieces.

Finally, a customer redemption unit is engaged to transmit a complete set of jigsaw pieces to the server redemption unit after a customer jigsaw unit has the complete set of jigsaw pieces, where the server redemption unit examines the completeness of the set and the associated authentication data, and a reward is transmitted to the customer device if the examination is passed. With the present invention, the shortcomings of award collection prior art, such as boring and lack of interaction, are resolved. In contrast, the present invention is able to attract customers, promote business, enhance chance of redemption, and increased customer interaction.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the components of an award collection system according to an embodiment of the present invention.

FIG. 2 is a flow diagram showing the major steps of an award collection method according to an embodiment of the present invention.

FIG. 3 is a schematic diagram showing jigsaw pieces are transmitted from a server device to a store device.

FIG. 4 is a schematic diagram showing the location of a franchised store is indicated on a map of a customer device.

FIG. 5 is a schematic diagram showing jigsaw pieces are about to be dispensed from a store device.

FIG. 6 is a schematic diagram showing a customer receives jigsaw pieces from a store device.

FIG. 7 is a schematic diagram showing the selection of jigsaw pieces to exchange.

FIG. 8 is a schematic diagram showing jigsaw pieces are exchanged between two near-by customers.

FIG. 9 is a schematic diagram showing rewards are redeemed by a customer device to a server device.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

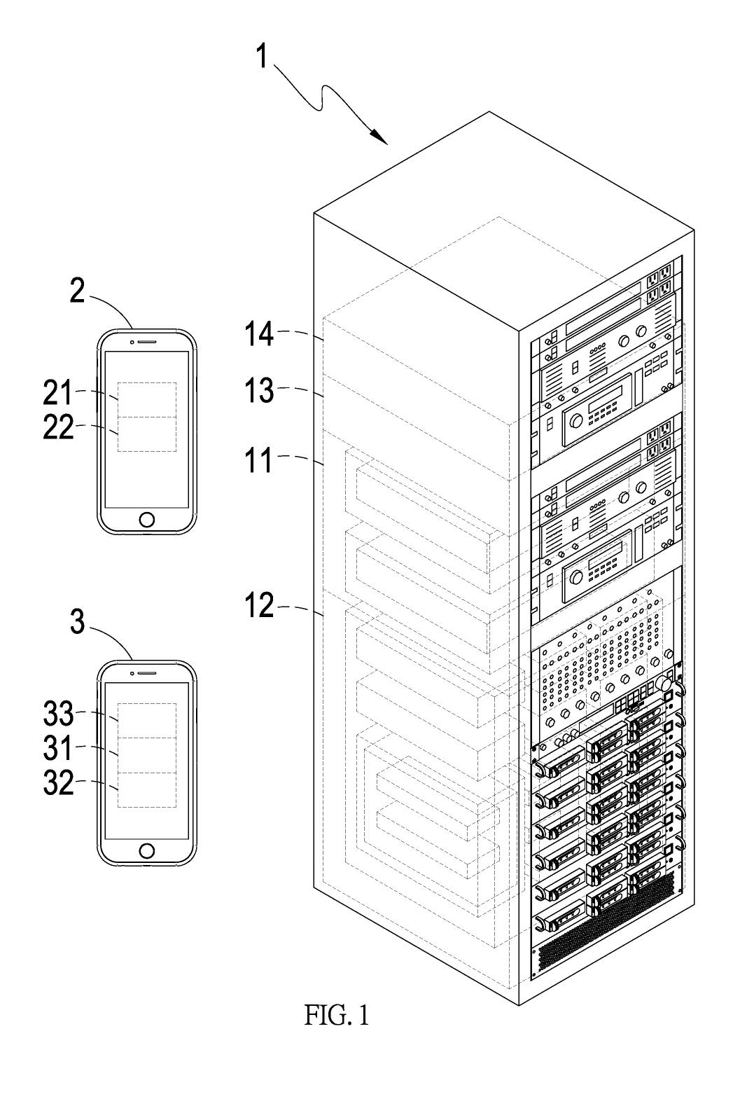

As shown in FIG. 1, a reward collection system according to an embodiment of the present invention includes at least a server device 1, at least a store device 2, and at least a customer device 3. The server device 1 includes a server jigsaw unit 11, a map unit 12, a server exchange unit 13, and a server redemption unit 14. The server jigsaw unit 11 generates a number of jigsaw pieces for customer collection. Each jigsaw piece may be a text segment and a number of the jigsaw pieces may be arranged into a specific text string. Alternatively, each jigsaw piece may be a graphical piece and a number of the jigsaw pieces may be arranged into a specific graphical pattern. Each jigsaw piece includes an authentication datum for anti-counterfeiting. The map unit 12 provides a number of franchised store data regarding stores participating the reward collection system, a number of general store data, and a map datum where the franchised and general store locations are marked for customer inspection. Each franchised store datum includes at least a description to the store's service, an appraisal for the store, and a count of jigsaw pieces remaining in the store. The map unit 12 further provides a number of exchange data for customers to seek other customers to exchange jigsaw pieces. The server exchange unit 13 provides customer devices 3 to exchange jigsaw pieces. The server redemption unit 14 allows customer devices 3 to redeem their collected jigsaw pieces.

Each store device 2 is data-linked with the server device 1, and includes a store jigsaw unit 21 for receiving and storing jigsaw pieces from the server jigsaw unit 11, and a store security unit 22 for the prevention of fraud. Each store device 2 may be a cellular phone, a computer, a notebook computer, a tablet computer, a Personal Digital Assistant (PDA), etc.

Each customer device 3 is data-linked with the server device 1, and includes at least a customer jigsaw unit 31 for receiving and storing jigsaw pieces from the store jigsaw unit 21, a customer exchange unit 32 for the exchange of jigsaw units with another customer exchange unit 32, and a customer redemption unit 33 for the redemption of a reward using the stored jigsaw pieces. Each customer device 3 may be a cellular phone, a computer, a notebook computer, a tablet computer, a Personal Digital Assistant (PDA), an intelligent wristband, etc.

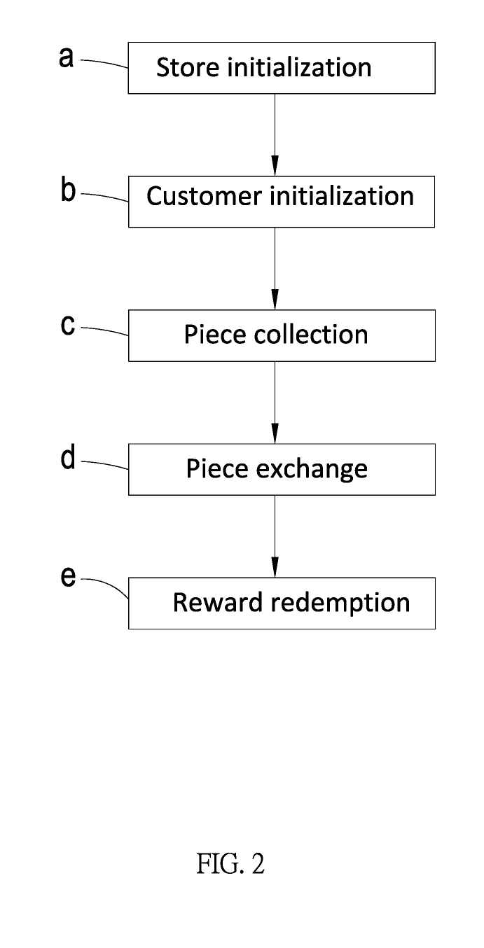

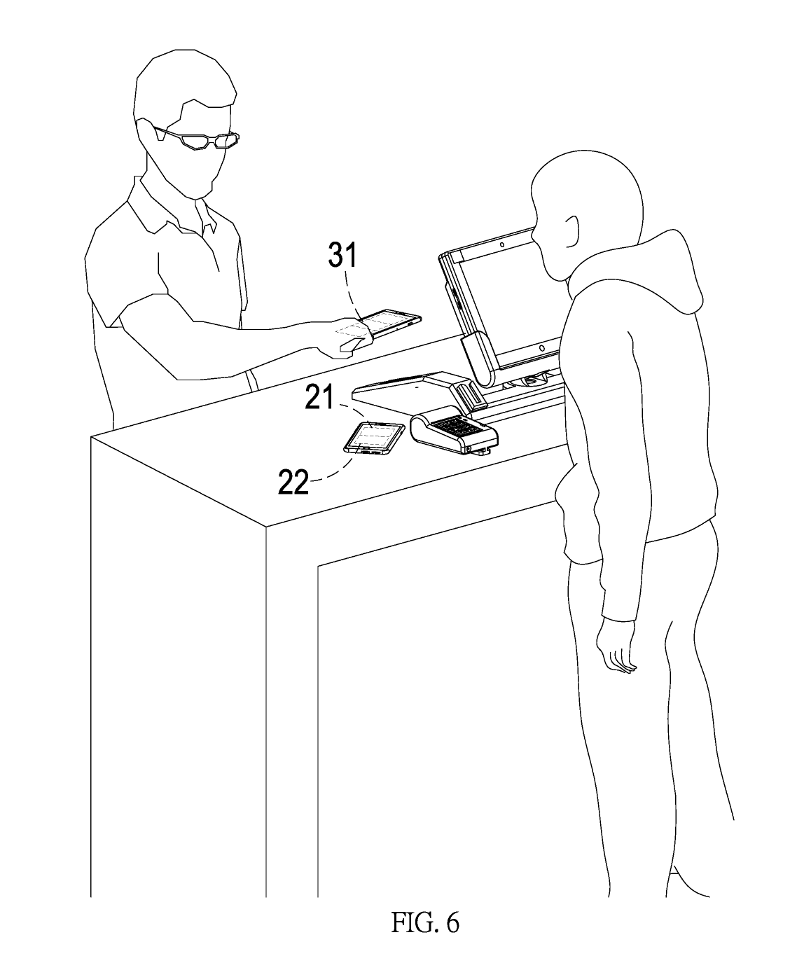

As shown in FIGS. 1 to 9, a related method of the reward collection system includes the steps of (a) store initialization, (b) customer initialization, (c) piece collection, (d) piece exchange, and (e) reward redemption.

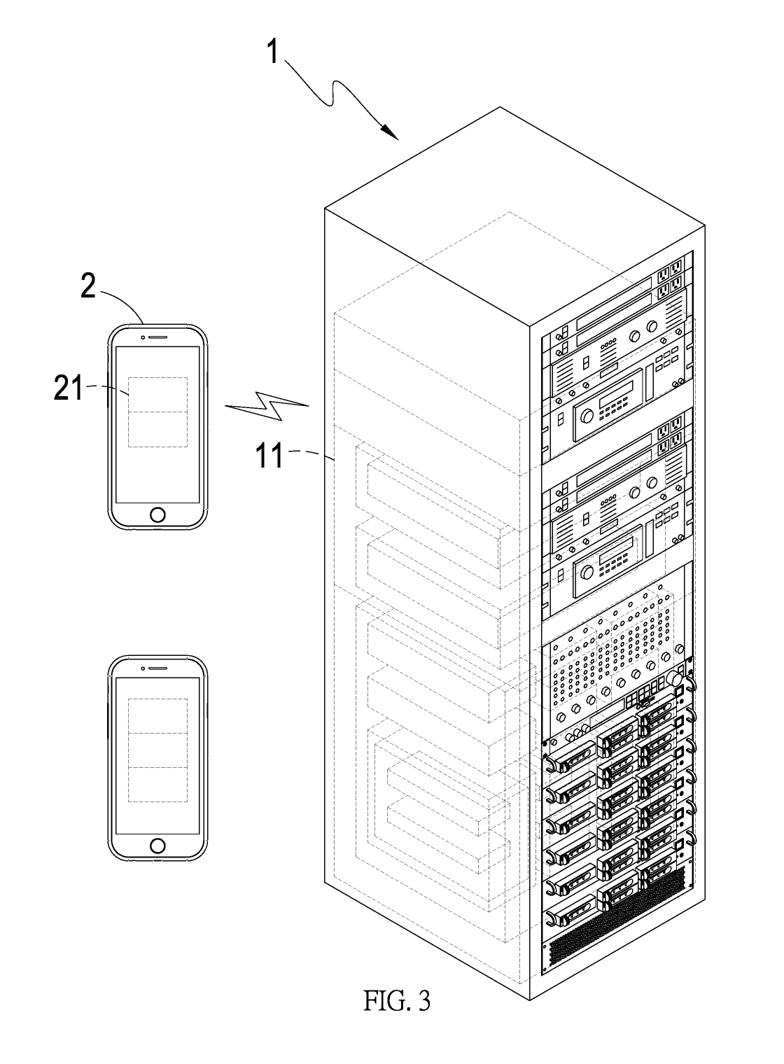

In step (a), as shown in FIG. 3, a franchised store has its store device 2 data-linked to the server device 1, and the server jigsaw unit 11 of the server device 1 delivers various jigsaw pieces with associated authentication data to the store jigsaw unit 21 of the store device 2.

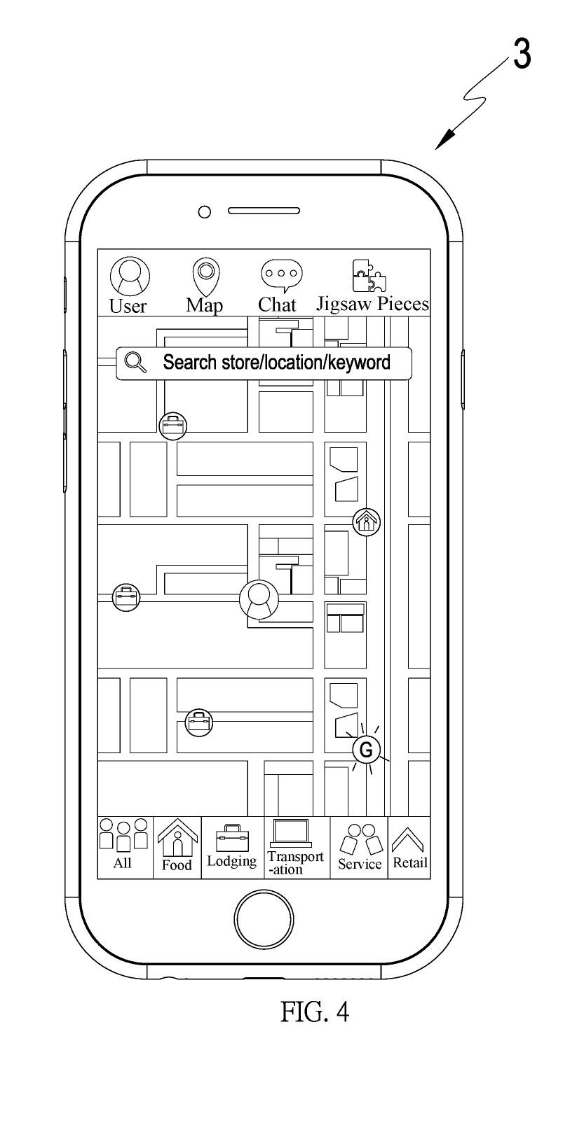

In step (b), as shown in FIG. 4, each customer device 3 is data-linked with the server device 1, and obtains the map datum, franchised store data, general store data from the map unit 12 of the server device 1. A customer therefore may inspect the map datum, locate surrounding general and franchised stores, and determine routes to the stores. Especially from the franchised store data (e.g., indicated by a flashed G in FIG. 4), the customer may learn the service provided by a specific franchised store, its appraisal, and how many jigsaw pieces are available there.

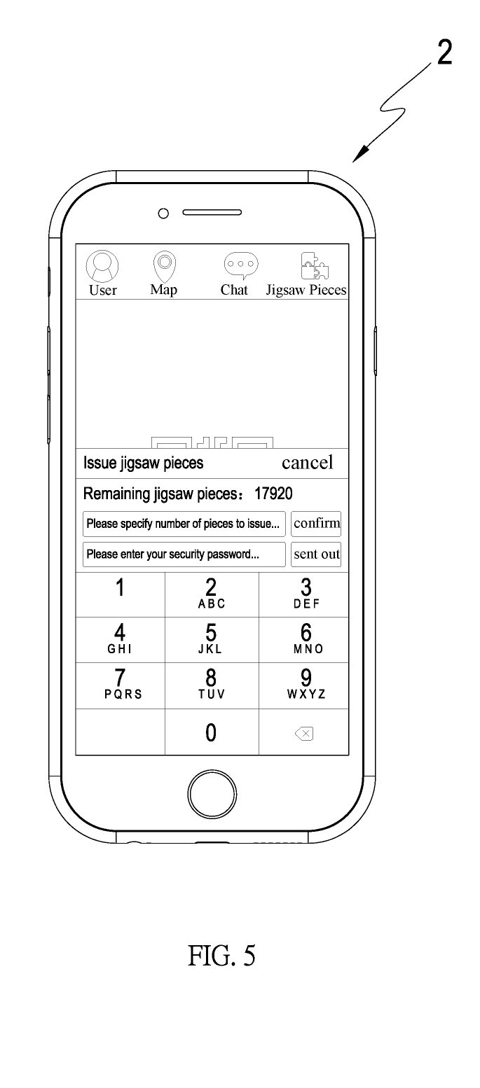

In step (c), as shown in FIGS. 5 to 7, after a customer's shopping in a franchised store, the store security unit 22 of the store device 2 unlocks and allows the store jigsaw unit 21 to transmit a specific number of jigsaw pieces to the customer jigsaw unit 31 of the customer device 3. In this manner, a customer may collect jigsaw pieces from any franchised store regardless whether the transaction is by cash or credit card. The jigsaw pieces may be transmitted through QR codes, or other similar mechanisms.

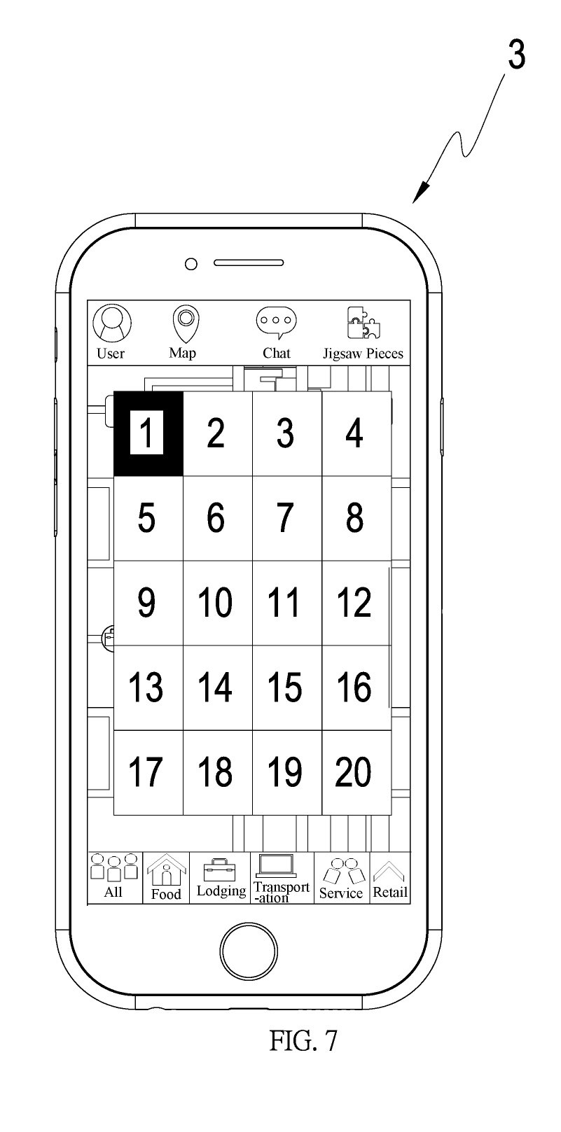

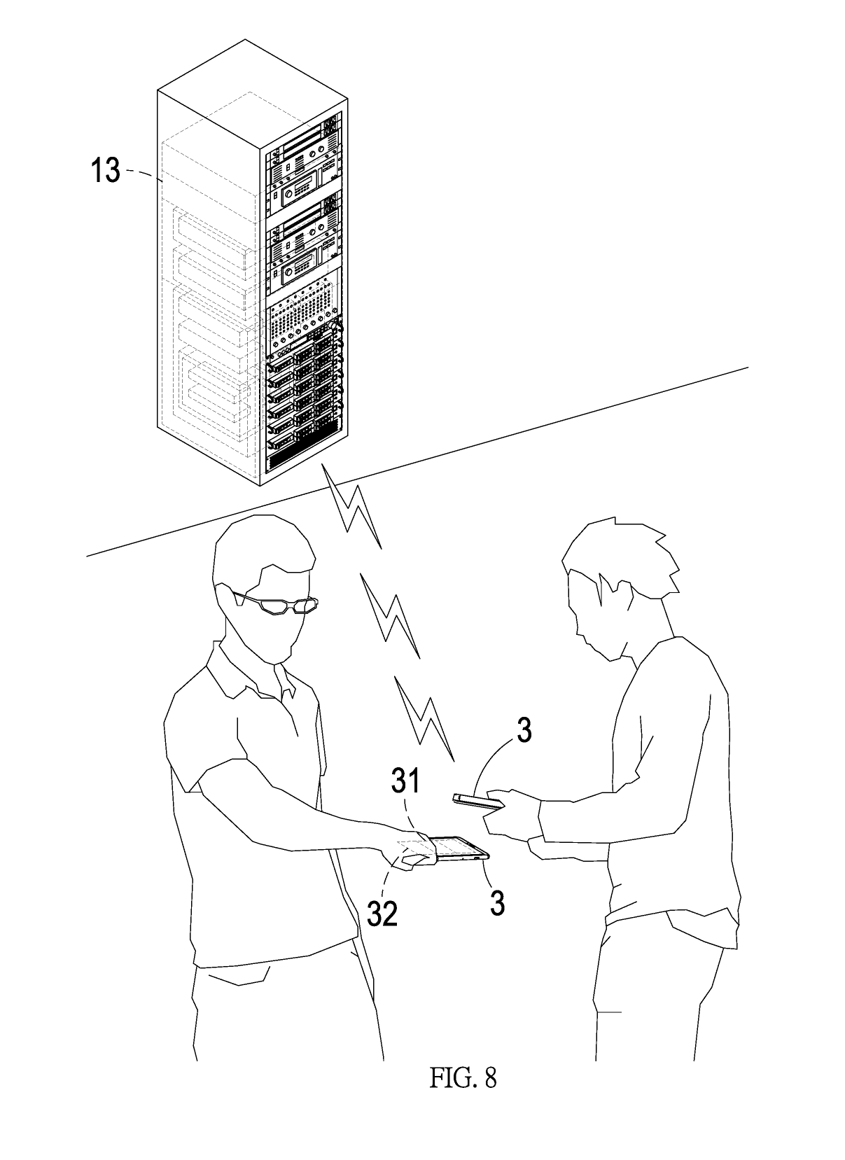

In step (d), as shown in FIGS. 7 and 8, since there are different sets of jigsaw pieces that may be pieced together into different text strings or graphical patterns, a customer may have repeated jigsaw pieces. And, rewards may be redeemed only when a complete text string or graphical pattern is achieved. The customer exchange unit 32 of the customer device 3 is data-linked with the server exchange unit 13 of the server device 1. The server exchange unit 13 determines whether two customer devices 3 are at close proximity and then allows the near-by customer exchange units 32 to exchange selected jigsaw pieces. The determination of proximity may be achieved using Global Positioning System (GPS), Near Field Communication (NFC), or similar means. In this manner, customer interaction, speed of jigsaw piece collection, and the chance of reward redemption may all be enhanced. In addition, customer locations and demands for various jigsaw pieces may be indicated in the map datum, so the customers may locate each other to facilitate exchange.

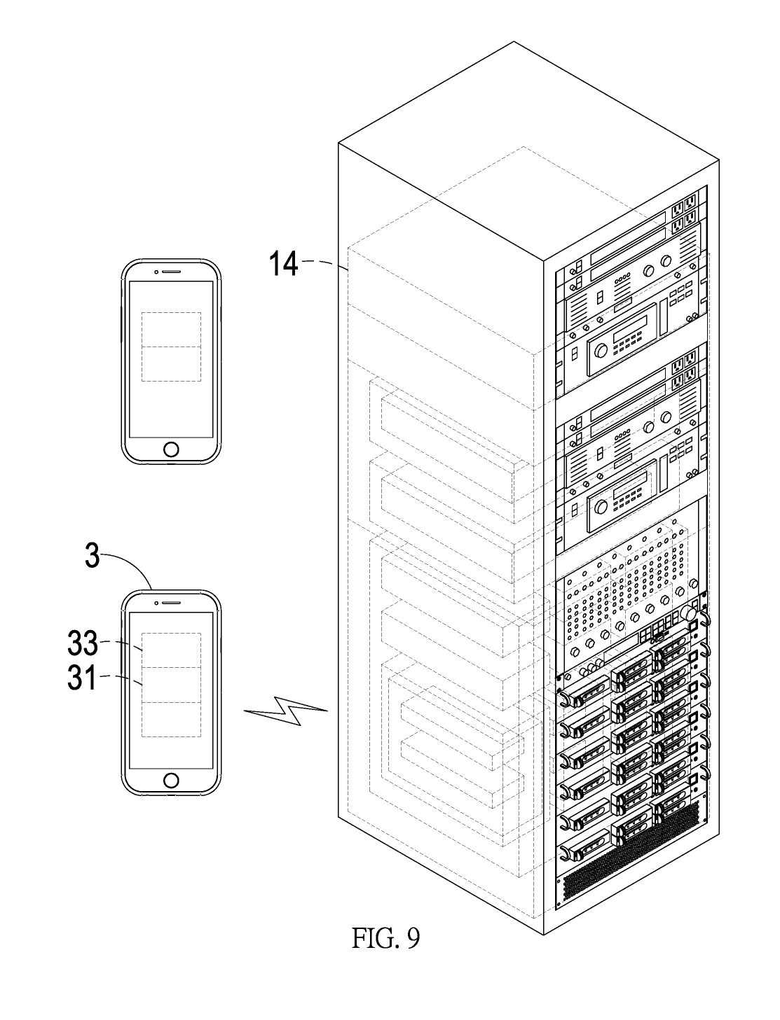

In step (e), as shown in FIG. 9, after the customer jigsaw unit 31 has a complete set of jigsaw pieces, the customer redemption unit 33 may be engaged to transmit the complete set of jigsaw pieces to the server redemption unit 14. The server redemption unit 14 examines the completeness of the set and the associated authentication data. If everything is OK, a reward is transmitted to the customer device 3 so that the customer may use the reward to get prizes or commodities from a franchised store. In this way, customer patronage is promoted and more stores would join the franchise.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An award collection system, comprising a server device, at least a store device, and at least a customer device, wherein
the server device comprises a server jigsaw unit, a map unit, a server exchange unit, and a server redemption unit;
the server jigsaw unit generates a plurality of jigsaw pieces for customer collection where each jigsaw piece is associated with an authentication datum for anti-counterfeiting;
the map unit provides a plurality of franchised store data regarding stores participating reward collection, a plurality of general store data, and a map datum through which the franchised and general store data are inspected;
the server exchange unit provides customer devices to exchange jigsaw pieces;
the server redemption unit allows customer devices to redeem their collected jigsaw pieces.
each store device is data-linked with the server device, and comprises a store jigsaw unit for receiving and storing jigsaw pieces from the server jigsaw unit, and a store security unit for the prevention of fraud; and
each customer device is data-linked with the server device, and comprises a customer jigsaw unit for receiving and storing jigsaw pieces from the store jigsaw unit, a customer exchange unit for the exchange of jigsaw units with another customer exchange unit, and a customer redemption unit for the redemption of a reward using the stored jigsaw pieces.

2. The award collection system according to claim 1, wherein each jigsaw piece is one of a text segment and a graphical piece; and a specific text string or a specific graphical pattern is achieved by arranging a plurality of the jigsaw pieces.

3. The award collection system according to claim 1, wherein the map unit further provides a plurality of exchange data for customers to seek other customers to exchange jigsaw pieces.

4. The award collection system according to claim 1, wherein each franchised store datum comprises a description to a franchised store's service, an appraisal for the franchised store, and a count of jigsaw pieces remaining in the franchised store.

5. An award collection method applied to the award collection system as claimed in claim 1, comprising
(a) data-linking each store device to the server device, where the server jigsaw unit of the server device delivers various jigsaw pieces with associated authentication data to the store jigsaw units of the store devices;
(b) data-linking each customer device to the server device, where the map datum, franchised store data, general store data are obtained from the map unit of the server device so that a customer is able to inspect the map datum of a customer device, locate surrounding general and franchised stores, and determine routes to the stores;
(c) the store security unit of a store device unlocking the store jigsaw unit to transmit a specific number of jigsaw pieces to the customer jigsaw unit of the customer device, after the customer has shopped in a franchised store;
(d) data-linking the customer exchange unit of the customer device with the server exchange unit of the server device, where the server exchange unit determines whether two customer devices are at close proximity and then allows the near-by customer exchange units to exchange selected jigsaw pieces; and
(e) engaging a customer redemption unit to transmit a complete set of jigsaw pieces to the server redemption unit after a customer jigsaw unit has the complete set of jigsaw pieces, where the server redemption unit examines the completeness of the set and the associated authentication data, a reward is transmitted to the customer device if the examination is passed.

6. The award collection method according to claim 5, wherein each jigsaw piece is one of a text segment and a graphical piece; and a specific text string or a specific graphical pattern is achieved by arranging a plurality of the jigsaw pieces.

7. The award collection method according to claim 5, wherein the map unit further provides a plurality of exchange data for customers to seek other customers to exchange jigsaw pieces.

8. The award collection system according to claim 1, wherein each franchised store datum comprises a description to a franchised store's service, an appraisal for the franchised store, and a count of jigsaw pieces remaining in the franchised store.
